(19) United States
(12) Patent Application Publication
(10) Pub. No.: US 2004/0151873 A1
(43) Pub. Date: Aug. 5, 2004

(54) IMPROVED MOUSEPAD

(76) Inventor: DAVID LIANG MABBUTT, SAN FRANCISCO, CA (US)

Correspondence Address: EDWIN A. SKOCH II, 67 WALL STREET, 22ND FLOOR, PMB#0029, NEW YORK, NY, 10005-3198, US

(21) Appl. No.: 10/707,437

(22) Filed: Dec. 14, 2003

Related U.S. Application Data
(60) Provisional application No. 60/441,410, filed on Jan. 18, 2003.

(51) Int. Cl. B32B 7/00

(52) U.S. Cl. 428/120

(57) ABSTRACT

The improved mousepad has one or more bumpers on the ends or sides of said mousepad, which prevent a computer mouse from traveling off the ends or sides of said mousepad while the mouse is in use, and which may be used as a promotional item and or miniature sport simulation game.

### CROSS REFERENCE TO RELATED APPLICATIONS

This patent application claims priority to provisional application U.S. PTO No. 60/441,410, filed Jan. 18, 2003.

### BACKGROUND OF INVENTION

The subject invention relates generally to pads for use with a computer mouse.

Computer mousepads are in broad, general use around the world, providing both a friction surface that facilitates the rotation of the tracking ball on the underside of the mouse, and also providing ornamentation to a desktop.

These pads are generally made from a thin, roughly square, piece of neoprene polymer, typically with a fabric covering.

They provide a soft, flexible, and ornamental pad which greatly improves the mouse function by creating a friction surface that the mouse's tracking ball essentially grips and rolls across. Mousepads were a great improvement over using the mouse on a hard, low-friction surface, like a slick desktop.

With existing mousepads, the problem exists that the user frequently runs the mouse off the ends or sides of the mousepad, while attempting to scroll the cursor around the screen with the mouse. Thus, problems solved by the mousepad created this new problem. The smaller size of the mousepad, compared to a desktop, requires the user to repeatedly pick the mouse up, replace it on top of the mousepad, and reposition it for continued use.

This further requires the user to maintain awareness of the position of the mouse itself in relationship to the mousepad-in addition to keeping visual track of the cursor on the screen-thus dividing the attention of the user between the task at hand on the computer screen, and the tangential and non-productive task of keeping the mouse aligned on the mousepad. Since the mouse was meant as a control mechanism for the on-screen cursor, any distraction from the screen wastes time, effort, attention, and, conceivably, reduces productivity.

Presently known art attempts to address this problem by sidestepping mousepads entirely, but has not solved the problem. One method of sidestepping this problem dispenses with the mouse entirely, using a trackball system.

In effect, it flips the mouse upside-down, and allows the user to spin the tracking ball directly, thus keeping the “mouse” stationary. Another method eliminates the tracking ball, using instead some type of optical system on the underside of the mouse, eliminating the mousepad.

A newer type of mouse uses an optical system, without any type of track ball. Optical sensors built into the bottom of the mouse register changes in the position of the mouse over a surface. The optical mouse eliminates the need for a mousepad, but still requires clear desk surface space for operation. Trackballs, as mentioned in the prior paragraph, create their own allocated desk space simply by taking up surface space. The optical mouse still requires open, allocated surface area to “roll” over, so the optical mouse, while not requiring a mousepad for use, still benefits from the use of a mousepad to maintain a clear desk surface area for use.

The following represents a list of known related art:

[Related Art]

| | | |
|---|---|---|
| U.S. Pat. No. 4,799,054 | House | Jan. 17, 1989 |
| U.S. Pat. No. 4,834,502 | Bristol | May 30, 1989 |
| U.S. Pat. No. D476,993 | Mabbutt | Jul. 8, 2003 |
| U.S. Pat. No. D476,661 | Mabbutt | Jul. 1, 2003 |
| U.S. Pat. No. D476,338 | Mabbutt | Jun. 24, 2003 |
| U.S. Pat. No. D476,014 | Mabbutt | Jun. 17, 2003 |

The teachings of each of the above-listed citations are herein incorporated by reference. However, none of the above inventions and patents, taken either singularly or in combination, is seen to describe the instant invention as claimed.

While the foregoing body of art indicates it to be well known how to create the basic mousepad, the art described above does not teach or suggest improvement which has the following desirable features: a bumper that prevents the mouse from traveling off the side or end of the mousepad while in use and preventing placement of items on or over the mousepad, other than the mouse. It, further, does not suggest the utility of using the mousepad as a promotional item by companies seeking to advertise using mousepads.

### SUMMARY OF INVENTION

The improved mousepad prevents the mouse from traveling off the edge of the mousepad by using one or more barriers at or near the edges. This barrier can be at the edge of the mousepad, or placed in from the edge, for aesthetic or design purposes. The upper edge of the mousepad, away from the user, is the most useful placement for the barrier.

The improved mousepad presents advantages, including: (1) preventing the mouse from traveling off the edge of the mousepad while in use; (2) allowing the mouse user to focus more attention on the computer screen, increasing productivity of the user; (3) allowing for simplicity in the manufacturing process; (4) providing an aesthetically pleasing and simultaneously useful product; (5) using a minimum of parts in construction and readily available and inexpensive materials, so that production costs are further minimized; (6) providing a surface and structure that can be used as a promotional tool; and (7) discouraging the user from placing items other than the mouse on or over the mousepad.

For an optical mouse, the same benefits are realized, since this improved mousepad provides all of the above advantages, as well as the added advantage provided by using this mousepad with an optical mouse: the mousepad acts as a desk surface space-holder. Using a mousepad with an optical mouse allocates space on the desktop for the operation of the mouse and helps keep that allocated space clear of desk clutter, such as paperwork.

Further, the mousepad, by resembling a sport or game in miniature, can also provide additional utility by allowing the mousepad to be used as the foundation for a game, mimicking the sport represented by the mousepad. This ability to play the sport in miniature also enhances the promotional or advertising utility of the mousepad.

In its simplest form, the improved mousepad uses one or more rigid plastic, wood, or metallic pieces inserted into the mousepad material near the edge of the mousepad, thereby anchoring the piece(s) in the pad material. The piece or pieces are mounted roughly perpendicular to the surface of the pad, so that the piece or pieces rise above the surface of the pad and provide a bumper for the mouse. In effect, the mouse will stop at the piece, thereby preventing the mouse from traveling off the edge of the mousepad.

The bumper pieces can be constructed of plastic, wood, or metallic material. These pieces can be constructed in a variety of shapes or forms. In this invention, the bumper pieces take the form of sports accessories, such as an American football goalpost, a soccer goalpost, a hockey goalpost, a golf hole post and flag, or a basketball post/ backboard/hoop combination.

All of the bumper pieces shown in this application are in the shape of common sports-related items, but this is not essential to the present invention. However, by constructing the invention using sport-related items, the mousepad has additional utility: the mousepad may also be used as a promotional item, promoting the sport represented by the mousepad design, sports players, equipment, or related items.

Further, by manufacturing the mousepad and its bumper feature to resemble fields or courts of common sports, the mousepad and its bumper feature can be used to create a game for the user of the mousepad, mimicking the sport, in miniature.

Additional advantages of the invention will be set forth in part in the description which follows, and in part will be obvious from the description, or may be learned by practice of the invention. The advantages of the invention may be realized and attained by means of the instrumentalities and combinations particularly pointed out in the attached claims.

Further benefits and advantages of the embodiments of the invention will become apparent from consideration of the following detailed description given with reference to the accompanying drawings, which specify and show preferred embodiments of the present invention.

### BRIEF DESCRIPTION OF DRAWINGS

FIG. 1 shows the first embodiment of the invention in a top perspective view thereof, showing a computer mouse placed on the invention for illustrative purposes only.

FIG. 2 shows the first embodiment of the invention: a top plan view thereof.

FIG. 3 shows the first embodiment of the invention: a bottom plan view thereof.

FIG. 4 shows the first embodiment of the invention: a rear elevation view thereof.

FIG. 5 shows the first embodiment of the invention: a front elevation view thereof.

FIG. 6 shows the first embodiment of the invention: a left elevation view thereof.

FIG. 7 shows the second embodiment of the invention: a top perspective view thereof.

FIG. 8 shows an altered second embodiment of the invention: a top perspective view thereof.

FIG. 9 shows a further, altered, second embodiment of the invention: a top perspective thereof, showing a computer mouse placed on the invention for illustrative purposes only.

FIG. 10 shows a third embodiment of the invention: a top perspective view thereof, showing a computer mouse placed on the invention for illustrative purposes only.

FIG. 11 shows the third embodiment of the invention: a top plan view thereof.

FIG. 12 shows the third embodiment of the invention: a bottom plan view thereof.

FIG. 13 shows the third embodiment of the invention: a rear elevation view thereof.

FIG. 14 shows the third embodiment of the invention: a front elevation view thereof.

FIG. 15 shows the third embodiment of the invention: a right elevation view thereof.

FIG. 16 shows a fourth embodiment of the invention: a top perspective view thereof.

FIG. 17 shows a fourth embodiment of the invention: a front elevation view thereof.

FIG. 18 shows a fourth embodiment of the invention: a rear elevation view thereof.

### DETAILED DESCRIPTION

Before beginning a detailed description of the subject invention, mention of the following is in order. When appropriate, like references and characters are used to designate identical, corresponding, or similar components in different figure drawings. The figure drawings associated with this disclosure are not drawn with strict dimensional accuracy, i.e., such drawings have been drafted with a focus on clarity of viewing and understanding rather than dimensional accuracy.

The basic pad used in construction of the invented apparatus is, itself, made of typical neoprene foam mousepad material and covering. Basic mousepads are very widely used and well known in the industry, and inexpensively fabricated.

Using basic neoprene foam is not an essential part of the present invention, but represents the preferred construction, due to its ease of manufacture, low cost, and wide availability.

The additional pieces, mentioned above, which act as a bumper or guard for the mouse, are themselves constructed of single-piece molded plastic, wood, or metallic material. Injection-molded plastic, while not essential for the present invention, is the preferred material for the bumper pieces, and is widely used and well known in the toy and sporting goods industries, and inexpensively fabricated.

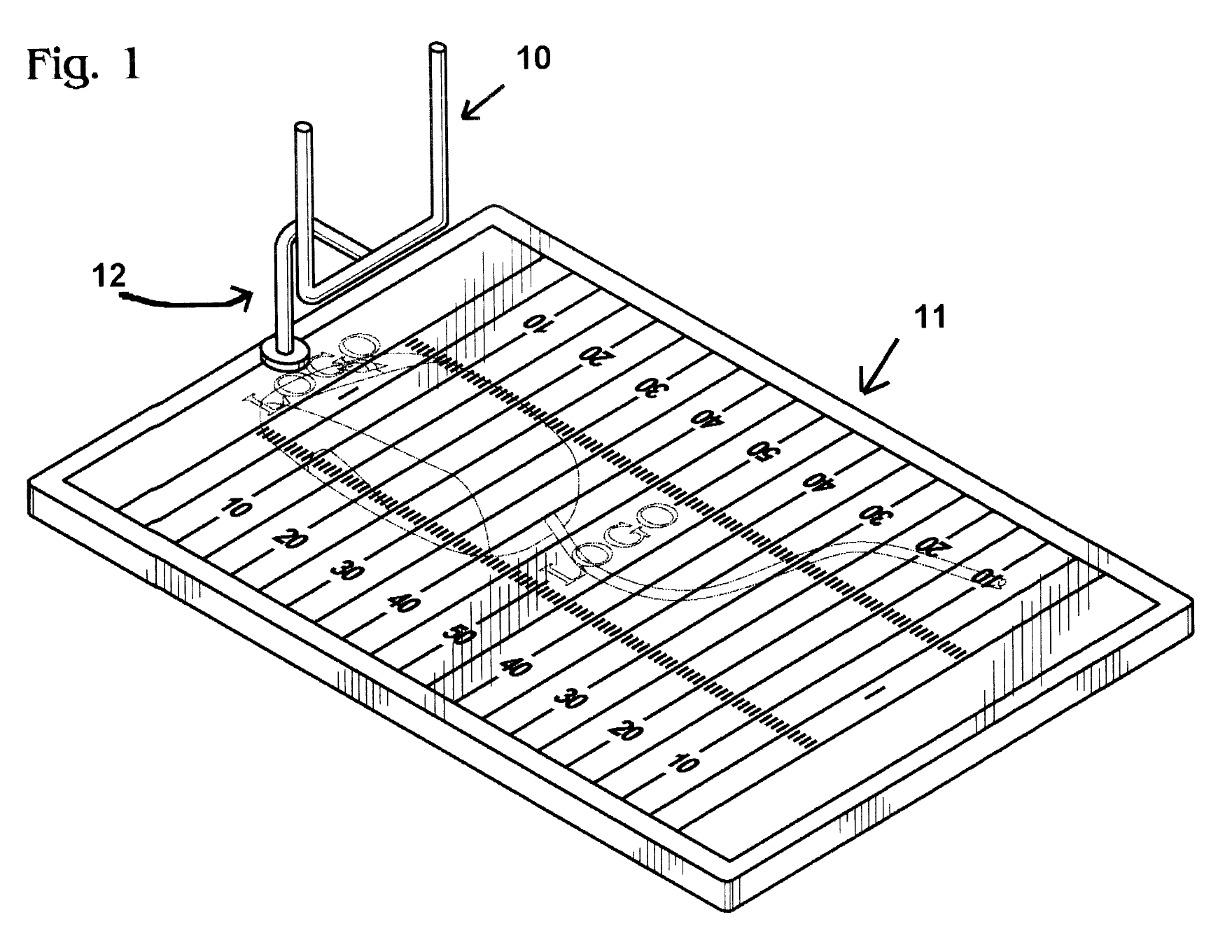

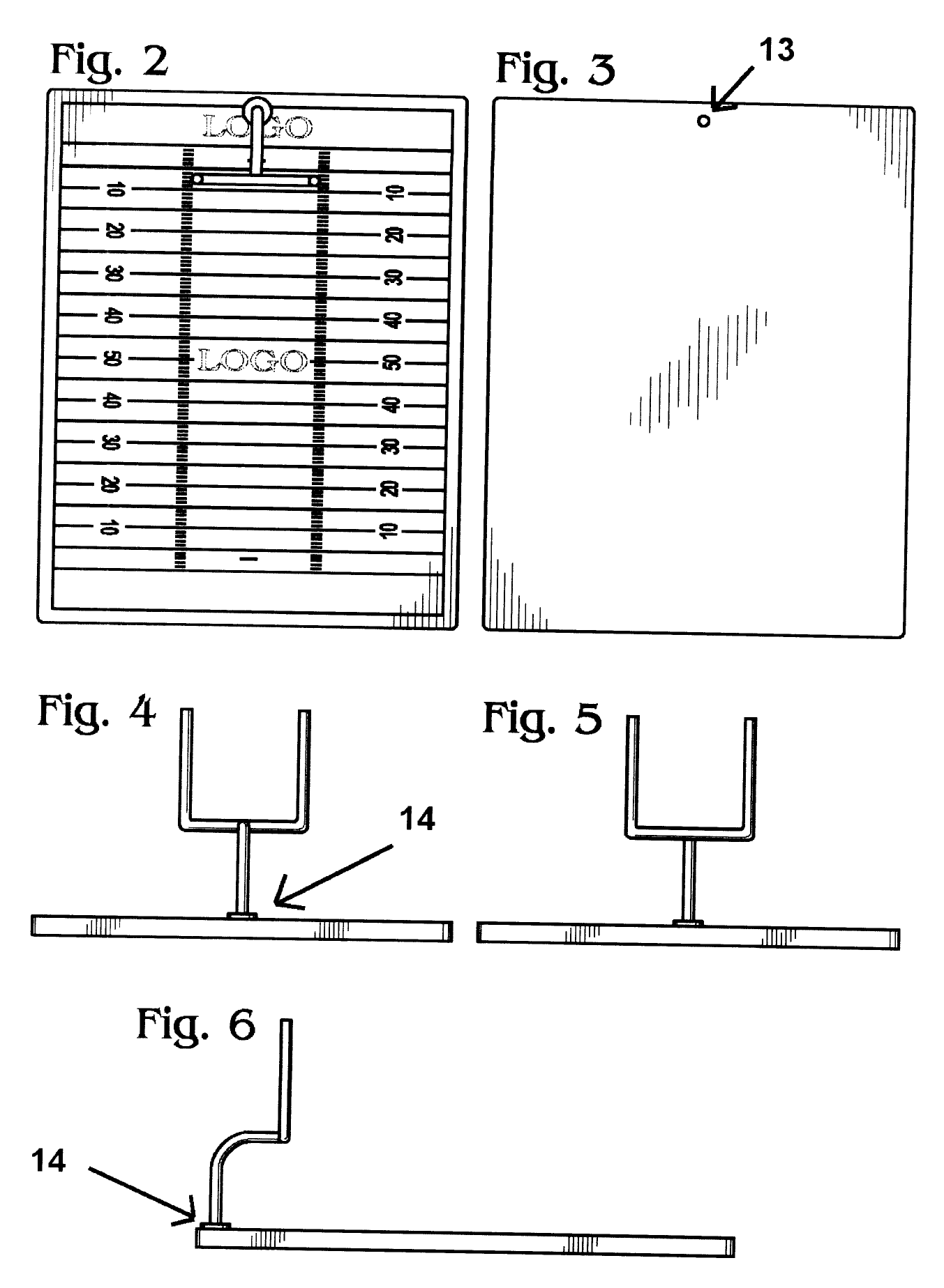

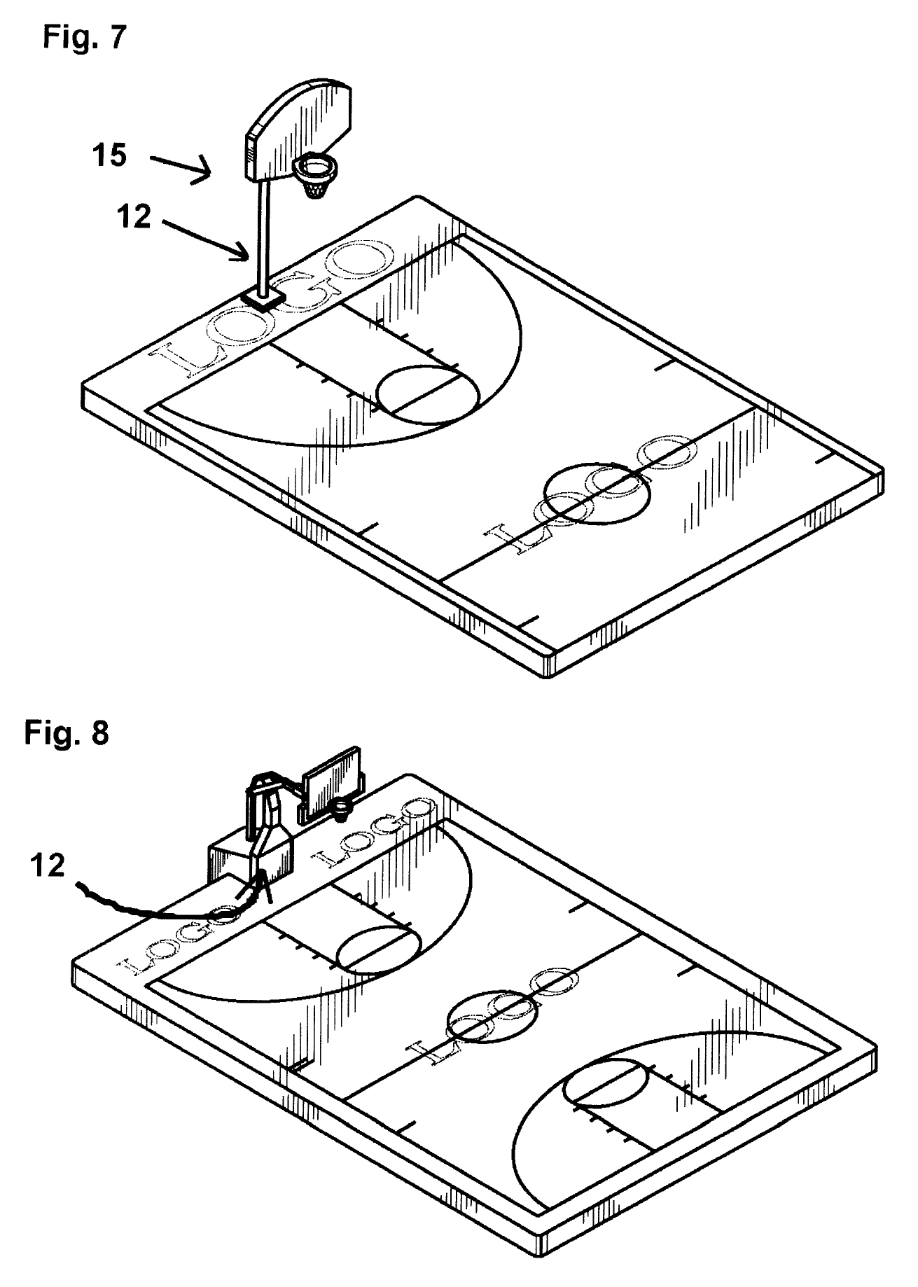

FIGS. 1-6 show the first embodiment of the invented apparatus, pictured in these figures as a mousepad resembling an American football field with a goalpost at one end. The goalpost, 10, pictured in these figures, protrudes in a three-dimensional fashion perpendicularly from the surface of the pad, 11. The goalpost functions as the bumper piece in this embodiment, and should, preferably, be constructed of a single piece of injection-molded plastic, as mentioned above. The lower area of the goalpost acts as the bumper, 12. The bumper function provides utility to the present invention, as mentioned in prior sections of this application. The mouse, while in use, is restrained from traveling off the end of the pad because it bumps up against the goalpost.

In this embodiment, the goalpost is attached to the pad by pushing it through a small hole in the pad material. FIG. 3 is a view from underneath the pad: the bottom of the goalpost can be seen sticking through to the underside of the pad, at 13, but, notably, that bottom is flush with the underside of the pad and does not protrude, as can be noted in FIGS. 4-6.

The three-dimensional nature of the bumper, coupled with the mousepad itself, serve to create additional utility for use with an optical mouse, as noted above. The mousepad serves as a place-holder on a surface for the exclusive use of the mouse. The mousepad and three-dimensional bumper prevent the user from putting other items on the mousepad area; in this fashion, the present invention is highly useful with optical mice. A user would be disinclined from trying to cover a mousepad with three-dimensional bumpers sticking up.

The upper surface of the pad can be decorated with corporate logos, field lines, numbers, signatures, or other graphics to enhance the invention's resemblance to an actual football field and/or for advertising or promotional purposes. All figures show some possible configurations of graphics, including illustrations of the placement of logo graphics on the upper surface of the pad.

In addition to the mouse-bumper utility of the invention, the presence of these graphics provides additional utility for the invention: graphics on the pad's upper surface, in conjunction with the shape and placement of the post itself, provides a vehicle for advertising or promoting the sport represented by the mousepad shape, or for promoting equipment or related items or even sports players, through the use of players' signatures, names or likenesses. For example, sports fans can be encouraged to obtain signatures of players on the upper surface of the pad, as a collector's item. The invention thus provides a vehicle by which sports products may be advertised in a durable medium. The pads can be used as promotional items. The invention, taken as a whole, can be, in effect, a specialized vehicle or packaging for advertising.

Graphics can be silk-screened, glued, or otherwise attached to the surface of the mousepad by any of several processes widely used in mousepad manufacturing currently. Manufacturing constraints can determine how the graphics will be affixed or applied to the surface of the mousepad.

None of the graphics represented in any of the figures for any of the embodiments are essential for the embodiments. The graphics presented merely represent possible or likely configurations of graphics on the different mousepads for the embodiments represented. They are certainly not exhaustive, nor is any particular configuration of graphics essential.

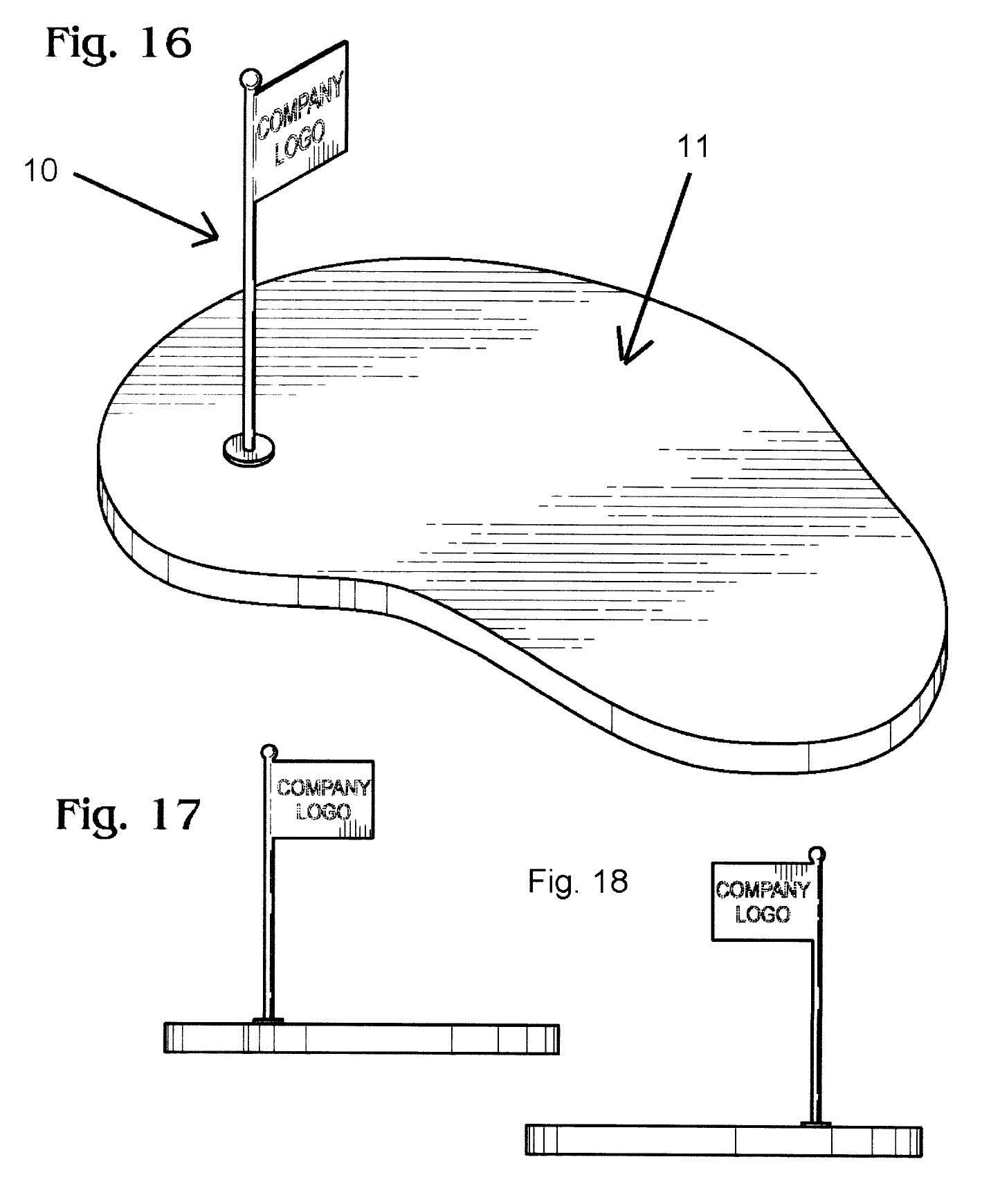

Nor is the use of graphics an essential element for creating this additional utility; the shape and bumper piece configuration of the mousepad alone can be sufficiently suggestive of the sport represented to promote the sport or provide a vehicle for advertising. For example, a golf green styled mousepad, as shown in FIG. 16, could be handed out at a golfing event for use in garnering the signature of a golf celebrity. In this fashion, the utility of the invention could be fully realized after the mousepad is in the hands of the ultimate user and without the use of graphics during manufacture.

In addition to the mouse-bumper utility of the invention and the promotional utility of the invention, the bumper piece shape and/or placement (in the shape of a goal post, for example) and the shape of the mousepad in each embodiment creates the possibility of using the mousepad as a game. That is, since the mousepad and goal post, for example, mimic the appearance of a sport in miniature, the mousepad may be used to play a facsimile of the mimicked sport in miniature.

Graphics, in the form of field or court lines on the mousepad, or other graphics mimicking field or court graphics used in the sport represented, while not essential, are recommended, and can enhance this additional game-playing utility.

It is possible, but not essential, to add accessories to the mousepad to further facilitate using the mousepad as the foundation for a sport.

Using a miniature “football” of some type, whether provided or sold with the mousepad, or arising from the imagination of the user, a miniature game of football can be played on the mousepad. The miniature “football” could be as elaborate as a small plastic piece which looks like a football, or as simple as a piece of paper. Rules for the game can be left to the imagination of the user or created and provided with the mousepad. The ability of the mousepad to be used as a game creates an additional utility for the mousepad that is a natural outgrowth of the utility previously mentioned. No particular accessory or accessories are essential for creating the additional game-playing utility. Manufacturing or marketing constraints can determine the complexity of the accessories, if any. This additional utility does not even require accessories be provided with the mousepad; as mentioned, the mousepad user can supply his or her own accessory or accessories and use the mousepad as the game foundation.

Although not essential to the invention, it is recommended that the very bottom of the bumper piece in each of the embodiments be enlarged several millimeters wider than the width of the rest of the piece, so that the bumper piece is more likely to stay anchored in the pad. This can easily be accomplished by, for example, forming a small, circular ball at the very bottom of the bumper piece. This is not shown per se in the figures, because the bumper pieces are shown already inserted in the pad.

Additionally recommended but not essential to the invention, the shape of base of the bumper piece facilitates easy mounting to the pad. In FIGS. 4-6, the section of the bumper piece just above the surface of the pad has a flattened circular section, 14, that helps force the bumper piece to stand erect, even after repeated bumping with a mouse.

The fact that the bumper piece is anchored in the flexible material of the pad means that the bumper piece can repeatedly act as a bumper for the mouse and return to its original, upright position.

The bottom of the bumper piece could alternately use a similar circular section, if desired, to help anchor the bumper piece in the pad. Once again, these elements are not essential to the invention, just preferable.

FIGS. 7-9 show alternative embodiments of the invented apparatus, pictured in the figures as mousepads resembling whole or partial basketball courts with a combination post/backboard/basket at one end of the simulated courts. This post, 15, has the same function, is similarly constructed, and is connected in the same fashion as the American football-style goalpost in FIGS. 1-6: a hole can be made in the pad material and the post can be inserted into the hole in the pad. The post is the bumper piece.

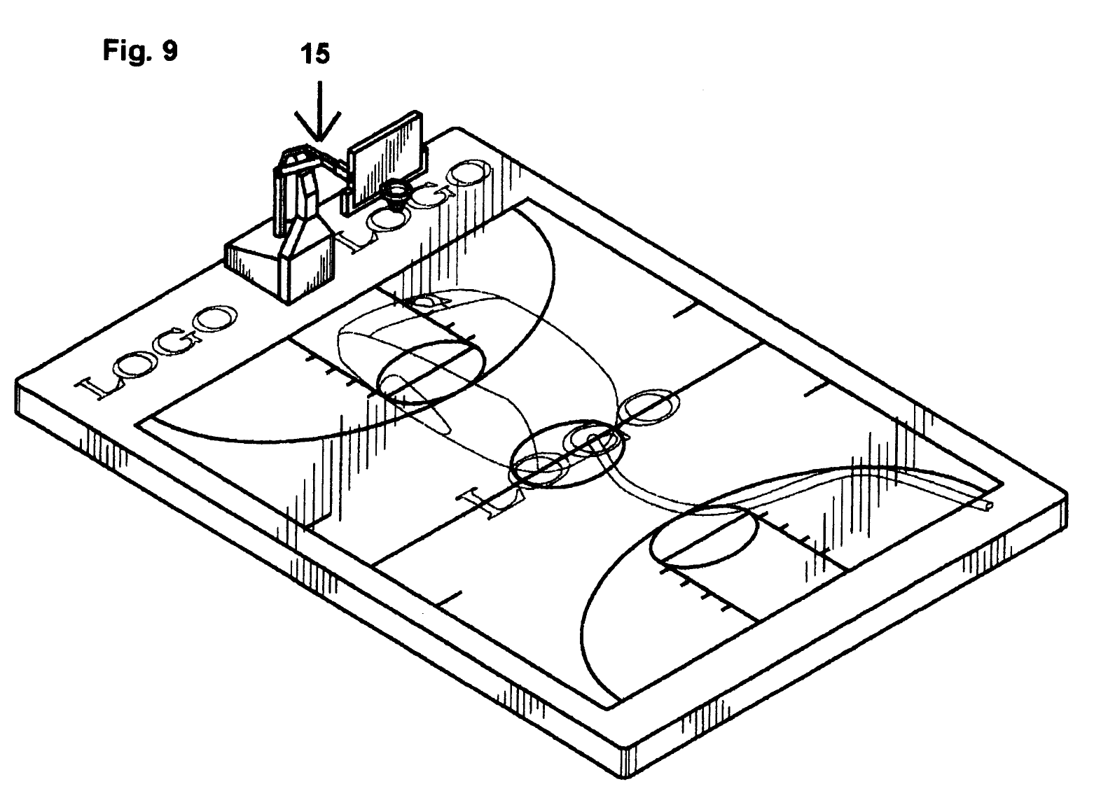

The broader base of the posts in FIGS. 8-9 make the use of more than one post holes into the pad feasible and even recommended, while not essential. Multiple attachment points for the post can increase the utility and durability of the invention by distributing the force of impacts by the mouse into more than one attachment point.

The lower area of the post on each of these figures is the bumper, 12, which provides utility in the invention by preventing the mouse from going off the pad.

FIG. 7 shows a squared base to the post, 15, similar to the circular section, 14, mentioned above and shown in FIGS. 4-6: there is no advantage to the square post base over the circular section, either can be used interchangeably with single posts with the same advantages. Aesthetic or manufacturing concerns can be used to determine which is used; the utility will be the same.

The embodiment presented in FIG. 8 shows an alternative to the previous embodiments in that not only does the basketball post resemble those used in professional and college basketball games in its shape, as in FIG. 9 as well, but the post extends off the edge of the pad. This configuration of the post constitutes a possible alteration to the connection of the posts to the mousepad, in that it provides a greater connection area to the pad for greater durability and further lateral stability to forces from being impacted by the mouse. By using a wider base, multiple connection points can be used, as described in the next paragraph, or the base can be attached using adhesives, rather than post insertion into a hole in the pad. Thus, the utility of the invention is increased over other embodiments with more minimal bumpers or attachment points.

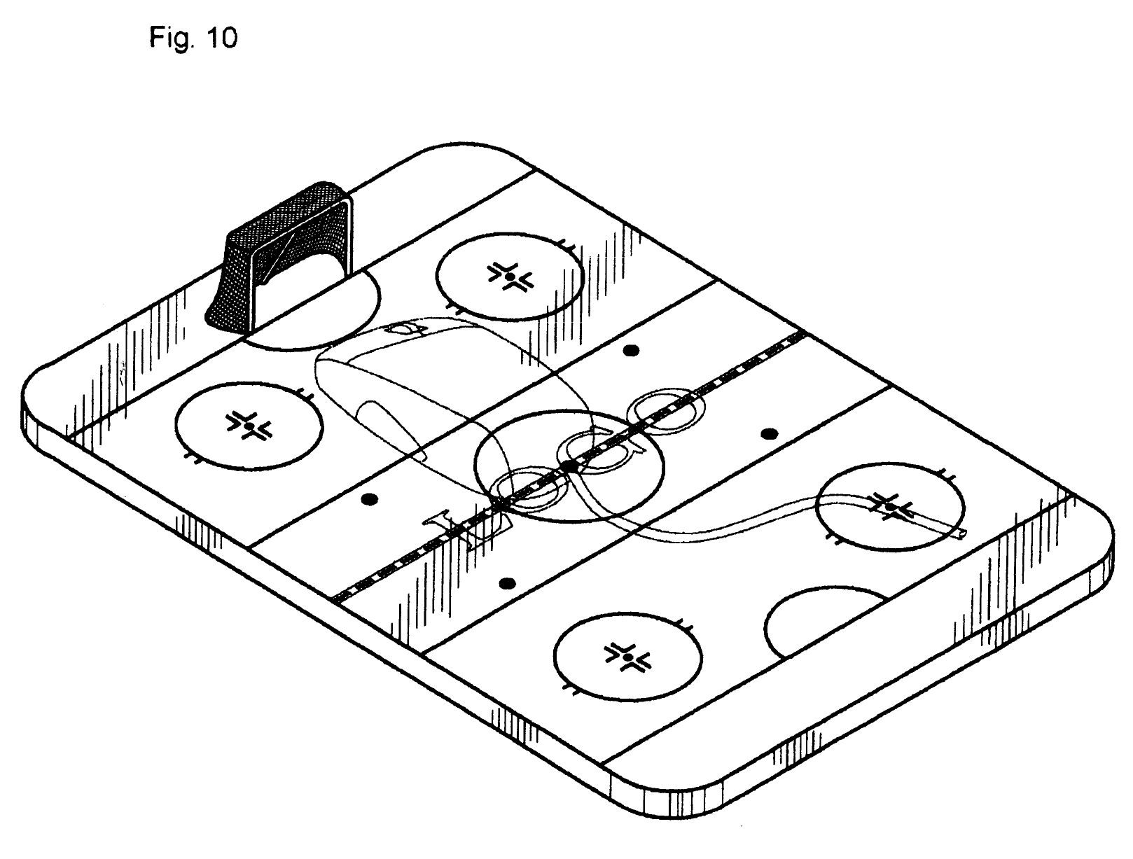

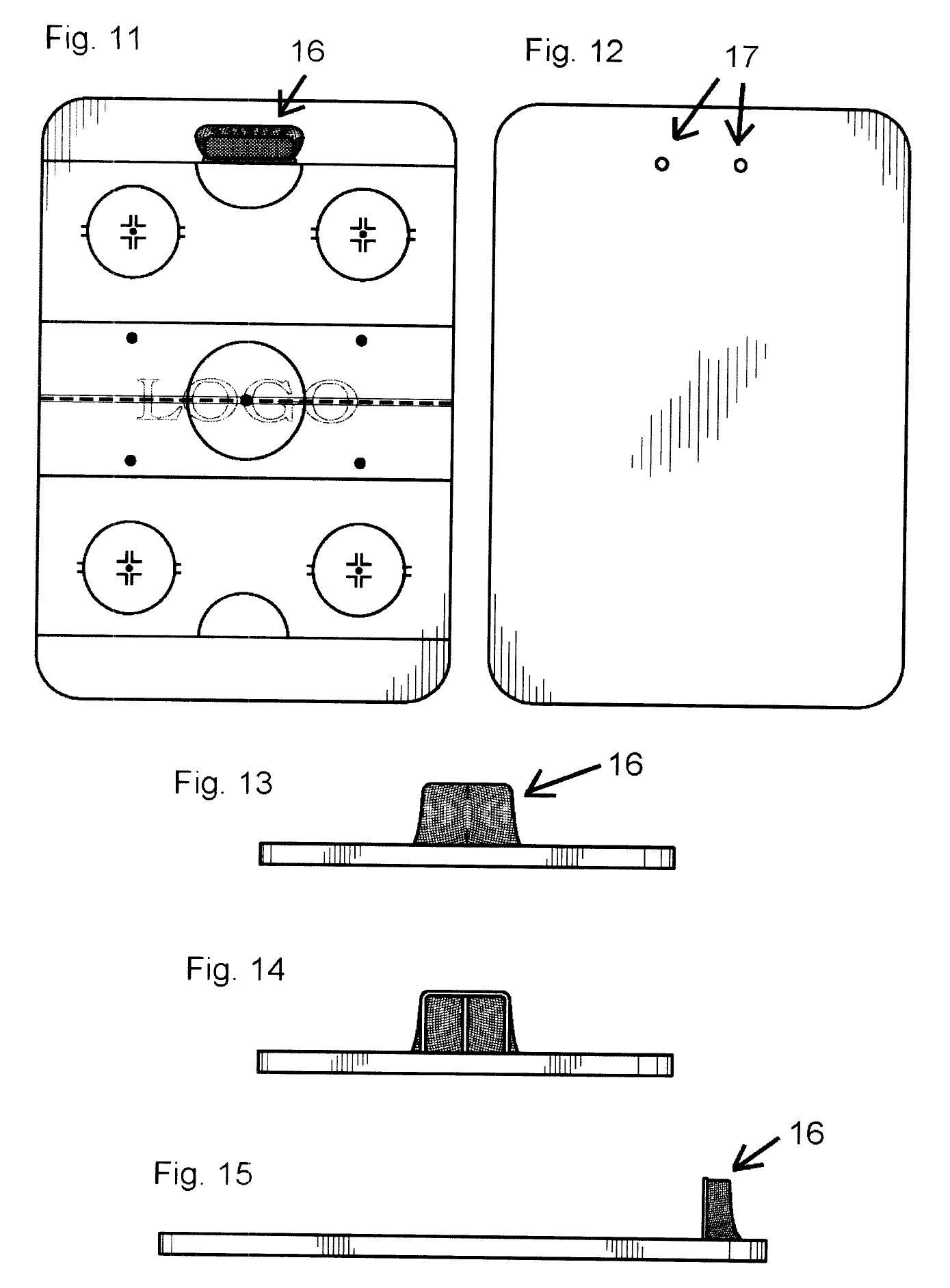

The alternative embodiment in FIGS. 10-15 uses another alternative connection means. Rather than a single post, the attachment of the bumper piece in FIGS. 10-15 uses multiple attachment points, sunk into holes in the pad material. The goal, 16, acts as the bumper piece. As shown in the figures, the goal (and field lines) resemble that of a hockey rink. As such, the hockey-goal-shaped post can be attached to the pad in two or more places. FIG. 12 illustrates the view from underneath the pad, showing two attachment points for the goal, labeled 17. Of course, although it is not essential, more than two attachment points can be used for attaching any of the posts in any of this embodiments or any other embodiment with a broader base or contact area between the bumper piece and the pad; this would obviously be true for the embodiments shown in FIGS. 8 and 9.

Another alternative embodiment is shown in FIGS. 16-18. In those figures, the mousepad resembles a golf course green with simulated hole, post, and flag. The post, 10, is attached to the pad, 11, as in the previous embodiments. Once again, the post functions as the bumper piece.

In any of the embodiments, a second post or goal can be added as another bumper elsewhere on the simulated “fields” in order to provide more utility in preventing the mouse from traveling off the edges of the mousepad.

Further, although not represented in the figures, other artifacts could be attached to the pads and used as bumpers around the edges of the mousepad. For example, it is possible to attach to the edges of the hockey rink pad an upright border, around three sides of the rink, in addition to the goal itself, and of a similar height as the goal. This way, three sides of the rink would be walled off, preventing the mouse from traveling off the edge of the mousepad. In real life, the borders of a hockey rink are commonly referred to as “the glass,” and could, in this example on the mousepad, be made from the same type of plastic, wood, or metal and mounted in a similar fashion to the goals or goal posts. This border would appear as a thin fence-like structure attached to, and rising in a perpendicular fashion from, the pad, surrounding the pad, and acting as bumpers. They could be attached in much the same way as the hockey goal itself: posts sunk into holes in the pad material. These side borders of the “rink” could even contain graphics to provide further utility, as advertising, as mentioned above. Similar walls, edges, or borders could be placed on any of the embodiments to enhance utility and provide surfaces for promotional graphics.

In addition to the miniature “football” mentioned above, any of the embodiments can come equipped with items to facilitate game play with the particular embodiment, such as, for example, a miniature ball of the type used in the sport represented, as well as any other ancillary miniature “equipment” used in the sport. For example, the golf green mousepad can come equipped with a miniature golf club and golf ball. Further, instructions for play can be included in the packaging.

It is possible to make the current invention using any other type of sports field as well, whether soccer field (with a goal like that used in the hockey rink embodiment), baseball diamond (with a back-stop, for example), cricket field or otherwise, so long as it has one or more bumpers at one or more of the sides. It is further possible to use the same general idea to construct a mousepad that resembles other common surfaces, so long as one or more bumpers are used. The bumpers could simulate any item, and the pad material could be decorated and colored in any fashion to simulate any surface. It is conceivable that a bumper or bumpers could be added to mousepads resembling billiards tables, a pinball machines, or any other myriad common sports or games with a relatively flat plane and a roughly perpendicular artifact rising from one or more sides that can be represented by the bumper.

In any case, the exact configuration of the mousepad and bumper is not essential, so long as the basic utility is accomplished: that is, a piece of plastic, wood, or metal is connected to, and rises in a roughly perpendicular manner from, the surface of the pad, near one or more of the pad's edges, providing a bumper for the mouse. The added utility of game-playing follows from the creation of a mousepad with bumper piece that resembles some type of sport or game mimicked in miniature.

The added utility of promotional or advertising use follows from the creation of a mousepad with bumper piece that resembles a sport or game in miniature, as well as any other easily, visually recognizable common items.

The place-holding utility and utility in preventing the user from covering the mousepad is a natural outgrowth of the three-dimensional nature of the invention.

1. An improved mousepad, comprising a mousepad with one or more connectedly attached members at or near the edge of the mousepad, said member or members protruding above the surface of said mousepad in a roughly perpendicular fashion and providing a barrier to discourage mouse movement off that edge of said mousepad where said member or members is located:

2. An improved mousepad, as in claim 1, wherein said member or members is in the shape of a hockey goal and said mousepad has the appearance of a full or partial hockey rink.

3. An improved mousepad, as in claim 2, further comprising graphics or text, used for promotional purposes.

4. An improved mousepad, as in claim 1, wherein said member or members is in the shape of a basketball post, backboard, and hoop and said mousepad has the appearance of a full or partial basketball court.

5. An improved mousepad, as in claim 4, further comprising graphics or text used for promotional purposes.

6. An improved mousepad, as in claim 1, wherein said member or members is in the shape of a golf hole, post, and flag and said mousepad has the appearance of a full or partial golf green.

7. An improved mousepad, as in claim 6, further comprising graphics or text, used for promotional purposes.

8. An improved mousepad, as in claim 1, wherein said member is in the shape of a football goalpost and said mousepad has the appearance of a full or partial football field.

9. An improved mousepad, as in claim 8, further comprising graphics or text, used for promotional purposes.

10. An improved mousepad, comprising a mousepad with one or more raised members near the periphery of said mousepad, said member providing a barrier to mouse movement off that mousepad edge where said member is placed.

11. An improved mousepad that can be used as an entertainment device, comprising: a mousepad resembling the playing surface of a sport in miniature and one or more miniature accessories used in said sport, used to play a facsimile of said sport.

12. An improved mousepad that can be used as a promotional device, comprising a mousepad resembling the playing surface of a sport in miniature.

13. An improved mousepad, as in claim 1, wherein said mousepad further comprises a porous surface that can be written on.

14. An improved mousepad that can be used with an optical mouse, comprising a mousepad with one or more connectedly attached members at or near the edge of the mousepad, said member or members protruding above the surface of said mousepad in a roughly perpendicular fashion and providing a barrier to discourage the user from placing items on or over said mousepad.
